(19) United States
(12) Patent Application Publication
(10) Pub. No.: US 2013/0155502 A1
(43) Pub. Date: Jun. 20, 2013

(54) AUTOSTEREOSCOPIC 3-DIMENSIONAL (3D) DISPLAY APPARATUS AND DISPLAY METHOD THEREOF

(71) Applicants: Tae-Jin KWAK, Daejeon (KR); Hong-Kee KIM, Daejeon (KR); Jin-Sung CHOI, Daejeon (KR); Jin-Ho KIM, Daejeon (KR); Ki-Suk LEE, Daejeon (KR); Ho-Yong SEO, Seoul (KR); Geol CHOI, Daejeon (KR)

(72) Inventors: Tae-Jin KWAK, Daejeon (KR); Hong-Kee KIM, Daejeon (KR); Jin-Sung CHOI, Daejeon (KR); Jin-Ho KIM, Daejeon (KR); Ki-Suk LEE, Daejeon (KR); Ho-Yong SEO, Seoul (KR); Geol CHOI, Daejeon (KR)

(73) Assignee: Electronics and Telecommunications Research Institute, Daejeon (KR)

(21) Appl. No.: 13/557,120

(22) Filed: Jul. 24, 2012

(30) Foreign Application Priority Data
Dec. 19, 2011 (KR) 10-2011-0137553

(51) Int. Cl. G02B 27/22

(52) U.S. Cl. 359/462

(57) ABSTRACT

There are provided an autostereoscopic 3-Dimensional (3D) display apparatus and a display method thereof. In the autostereoscopic 3D display apparatus, a 3D display is disposed in a standing position, and a reflection structure reflects light emitted from the screen of the 3D display to provide a 3D image in a 3D space. Accordingly, a deflection of the 3D display is reduced so that a 3D image pattern having no distortion is formed.

### CROSS-REFERENCE TO RELATED APPLICATION

This application claims the benefit under 35 U.S.C. §119(a) of Korean Patent Application No. 10-2011-0137553, filed on Dec. 19, 2011, the entire disclosure of which is incorporated herein by reference for all purposes.

### BACKGROUND

1. Field

The following description relates to content providing technology, and more particularly, to an apparatus and method for providing 3-Dimensional (3D) image content.

2. Description of the Related Art

With depth and spatial information, 3-Dimensional (3D) images provide more realistic views than 2D images. The 3D images are based on space cognition in which a human's left and right eyes perceive an environment with the familiar property of volume, and the results of perception are interpreted in his or her brain. Such 3D images create a sense of liveliness and reality as when viewing real objects. Technology for providing 3D images is a kind of display technology for making 3D images with a sense of depth that was not possible with a typical 2D display to create a 3D effect.

One of various techniques of providing 3D images is a method of projecting 3D images into the air using a half reflection mirror in order to allow a user to view 3D images without wearing 3D glasses. However, the method may distort images depending on an arrangement structure of a display.

Meanwhile, U.S. Laid-open Patent Application No. 20080144175 discloses a display apparatus including a pyramidal semitransparent mirror and a 2D display mounted thereon, and U.S. Laid-open Patent Application No. 20040135744 discloses a convex semitransparent mirror and a stereoscopic 3D display disposed thereon or therebelow.

### SUMMARY

The following description relates to an autostereoscopic 3-Dimensional (3D) display apparatus capable of preventing distortion of 3D images due to an arrangement structure of a display, without having to change a projection method, and a display method thereof.

In one general aspect, there is provided an autostereoscopic 3-Dimensional (3D) display apparatus including: a 3D display disposed in a standing position and configured to output a 3D image; and a reflection structure configured to reflect the 3D image output from the 3D display and provide the 3D image in a 3D space.

The reflection structure may include a total reflection mirror configured to totally reflect light emitted from a screen of the 3D display and to change a direction of the light, and a half reflection mirror configured to half reflect the light reflected from the total reflection mirror, thereby providing the user with the 3D image.

In another general aspect, there is provided a method of displaying a 3D image using an autostereoscopic 3-Dimensional (3D) display apparatus, including: outputting a 3D image through a 3D display disposed in a standing position; and reflecting the 3D image output from the 3D display using a reflection structure to form the 3D image in a 3D space.

Other features and aspects will be apparent from the following detailed description, the drawings, and the claims.

### BRIEF DESCRIPTION OF THE DRAWINGS

FIG. 1 shows a configuration example of an autostereoscopic 3-Dimensional (3D) display apparatus.

FIG. 2 is a side view of the autostereoscopic 3D display apparatus shown in FIG. 1.

FIG. 3 shows a configuration of a conventional autostereoscopic 3D display apparatus.

FIG. 4 is a side view of the conventional autostereoscopic 3D display apparatus shown in FIG. 3.

FIG. 5 shows a configuration example of a 3D display shown in FIG. 1.

FIG. 6 is a reference view showing the constant interval between a parallax barrier and an image display unit in a parallax barrier type 3D display apparatus.

FIG. 7 is a reference view showing the non-uniform interval between a parallax barrier and an image display unit in a conventional parallax barrier type 3D display apparatus.

FIG. 8 is a reference view for explaining quality test results of a 3D display that is disposed in a standing position.

FIG. 9 is a reference view for explaining quality test results of a conventional 3D display that is lying in a horizontal position.

FIG. 10 is a flowchart illustrating an example of a method of displaying autostereoscopic 3D images.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

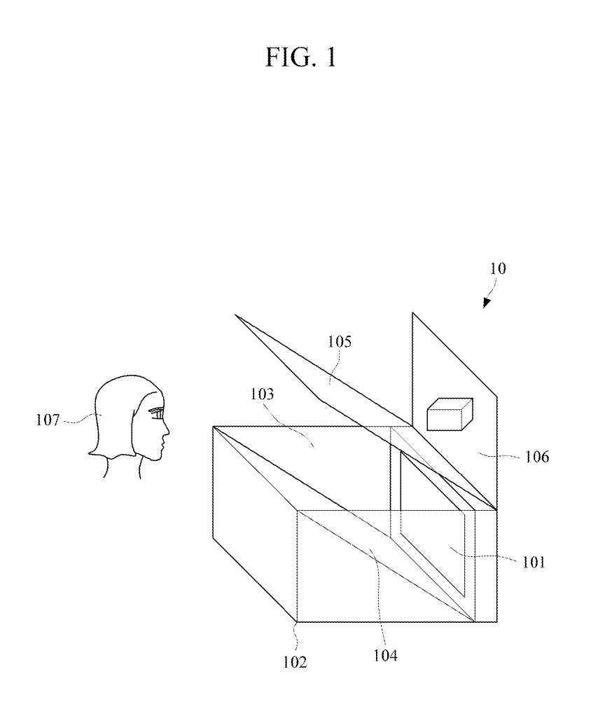

FIG. 1 shows a configuration example of an autostereoscopic 3-Dimensional (3D) display apparatus 10.

Referring to FIG. 1, the autostereoscopic 3D display apparatus 10 includes a 3D display 101 and a reflection structure, and the reflection structure includes a total reflection mirror 104 and a half reflection mirror 105.

The autostereoscopic 3D display apparatus 10 projects 3D images into the air using the reflection structure, thereby allowing a user to view the 3D images without wearing 3D glasses. That is, the autostereoscopic 3D display apparatus 10 uses a display method of providing an effect similar to a hologram by projecting 3D images into the air. The 3D display 101 creates 3D images, and is disposed in a standing position, as shown in FIG. 1. The reflection structure reflects 3D images output from the 3D display 101 and provides 3D images in a 3D space.

The total reflection mirror 104 totally reflects light emitted from the screen of the 3D display 101 to thereby change the direction of the light. The total reflection mirror 104 may be configured to meet the lower edge portion of the 3D display 101 at a predetermined angle, wherein the predetermined angle may be 45 degrees. The total reflection mirror 104 may have a flat structure.

The half reflection mirror 105 transmits half of the light reflected from the total reflection mirror 104, and reflects the remaining half to provide a user 107 with a 3D image. The half reflection mirror 105 may be disposed parallel to the total reflection mirror 104 and meet the upper edge portion of the 3D display 101 at a predetermined angle, wherein the predetermined angle may be 45 degrees. The half reflection mirror 105 also may have a flat structure.

A 3D image output from the 3D display 101 is reflected by the total reflection mirror 104 and the half reflection mirror 105 to form the 3D image on a projection surface 106 which is a virtual surface, so that the user 107 can view the 3D image on the projection surface. As illustrated in FIG. 1, the projection surface 106 is in line with the 3D display 101.

According to an example, the 3D display 101 and the total reflection mirror 104 are installed in an opaque frame 102, so that the user 107 can view neither the 3D display 101 nor the total reflection mirror 104 externally. The inner surface 103 of the opaque frame 102 may be coated with a nonreflective material.

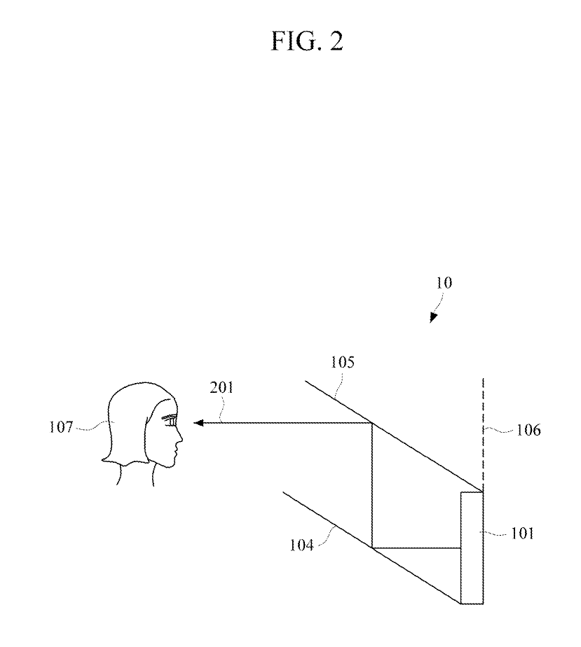

FIG. 2 is a side view of the autostereoscopic 3D display apparatus 10 shown in FIG. 1.

An operating process of the autostereoscopic 3D display apparatus 10 is as follows. The 3D display 101 that is disposed in a standing position outputs a 3D image, the total reflection mirror 104 totally reflects light emitted from the screen of the 3D display 101 to change the direction of the light, and the half reflection mirror 105 half reflects the light reflected from the total reflection mirror 104, thereby providing the user 107 with a 3D image. A reflection path along which the light emitted from the screen of the 3D display 101 is reflected is denoted by reference numeral 201 in FIG. 2.

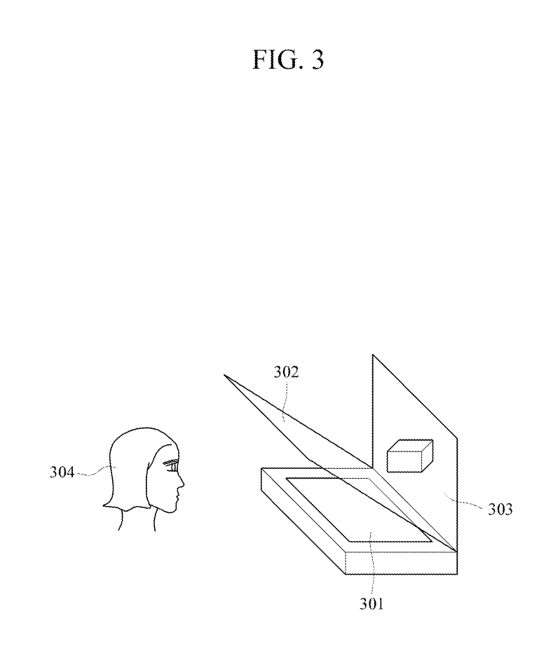

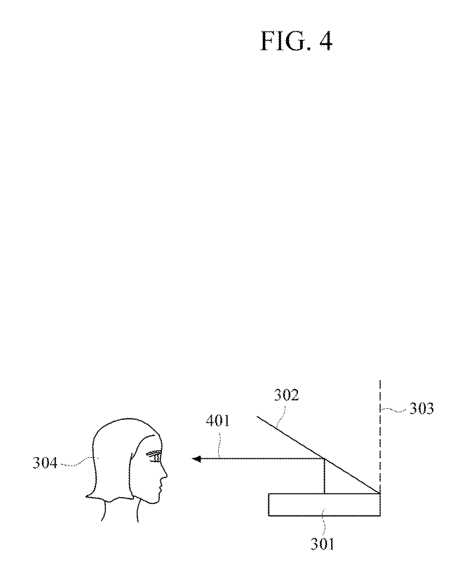

FIG. 3 shows a configuration of a conventional autostereoscopic 3D display apparatus, and FIG. 4 is a side view of the conventional autostereoscopic 3D display apparatus shown in FIG. 3.

As shown in FIG. 3, in the conventional autostereoscopic 3D display apparatus, a 3D display 301 is lying in a horizontal position. If the 3D display 301 outputs a 3D image, a half reflection mirror 302 half reflects light emitted from the screen of the 3D display 301 to thereby provide a user 304 with a 3D image. Here, a projection surface 303 is positioned perpendicular to the 3D display 301. Also, a reflection path along which the light emitted from the screen of the 3D display 301 is reflected is denoted by a reference numeral 401 in FIG. 4.

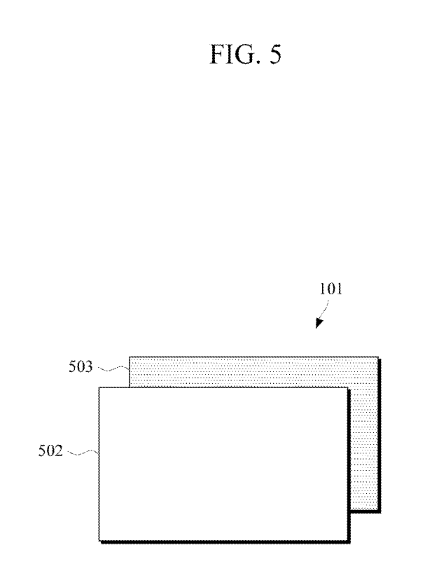

FIG. 5 shows a configuration example of the 3D display 101 shown in FIG. 1.

Referring to FIG. 5, the 3D display 101 includes an image display unit 503 and a view separation unit 502. The image display unit 503 is a panel for outputting images, and the view separation unit 502 is disposed in front of or behind the image display unit 503 to form a view blocking pattern for separating the display area of the image display unit 503 according to a user's left and right eyes such that different images are seen by the user's left and right eyes. The view separation unit 502 may be a parallax barrier.

Since the image display unit 503 and the view separation unit 502 are arranged in a standing state, the image display unit 503 and the view separation unit 502 are deflected less than when they are lying in a horizontal position, so that the interval between the image display unit 503 and the view separation unit 502 can be maintained constant.

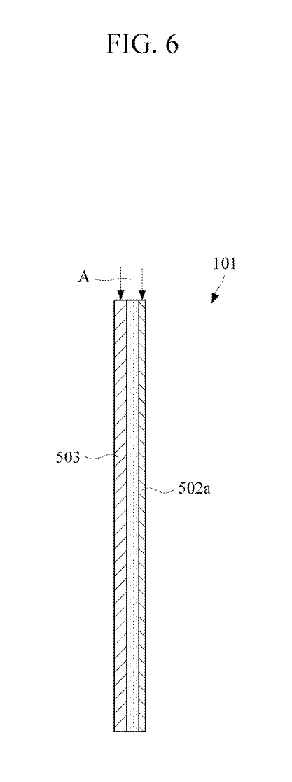

FIG. 6 is a reference view showing the constant interval between a parallax barrier 502a and an image display unit 503 in a parallax barrier type 3D display apparatus 10.

Referring to FIG. 6, when a parallel barrier type 3D display 101 that is disposed in a standing position is used, a deflection A of the 3D display 101 is reduced. Due to the reduction of the deflection A, the interval between the parallax barrier 502 and the image display unit 503 is maintained constant, as shown in FIG. 6.

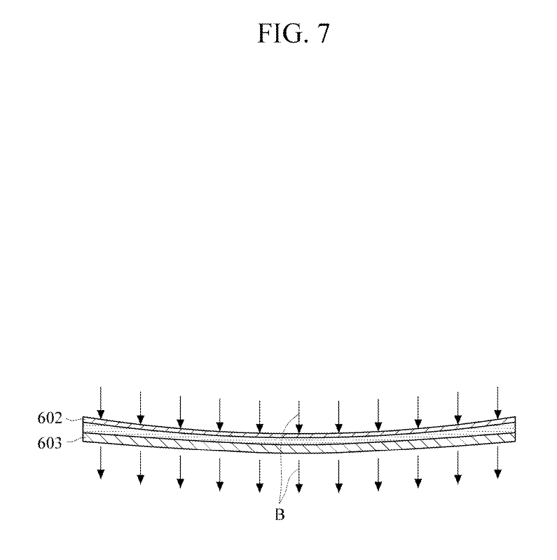

FIG. 7 is a reference view showing the non-uniform interval between a parallax barrier 602 and an image display unit 603 in a conventional parallax barrier type 3D display apparatus.

Referring to FIG. 7, when a parallax barrier type 3D display 101 that is lying in a horizontal position is used, a deflection B of the 3D display 101 increases compared to when the 3D display 101 is disposed in a standing position. Due to the increase of the deflection B, the interval between the parallax barrier 602 and the image display unit 603 becomes non-uniform.

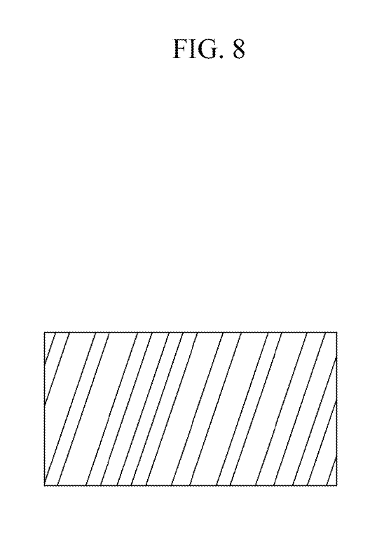

FIG. 8 is a reference view for explaining quality test results of the 3D display 101 that is disposed in the standing position.

Referring to FIG. 8, in the 3D display 101 disposed in the standing position, it is seen that a 3D image pattern appears without distortion.

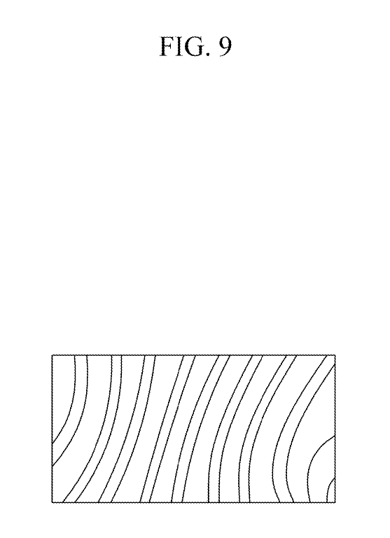

FIG. 9 is a reference view for explaining quality test results of a conventional 3D display that is lying in a horizontal position.

Referring to FIG. 9, in the conventional 3D display 101 lying in the horizontal position, it is seen that a 3D image pattern is distorted.

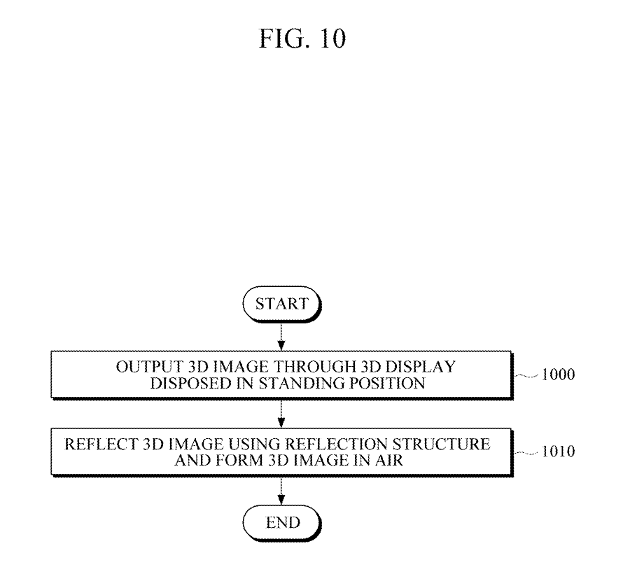

FIG. 10 is a flowchart illustrating an example of a method of displaying autostereoscopic 3D images. The display method of FIG. 10 may be performed by the autostereoscopic 3D display apparatus 10 shown in FIG. 1, and the following description will be given with reference to FIGS. 1 and 10.

First, the autostereoscopic 3D display apparatus 10 creates and outputs a 3D image through the 3D display 101 disposed in a standing position (1000). Then, the autostereoscopic 3D display apparatus 10 reflects the 3D image using the reflection structure and forms a 3D image in the air (1010). In operation 1010, the autostereoscopic 3D display apparatus 10 totally reflects light emitted from the screen of the 3D display 101 through the total reflection mirror 104 that meets the lower edge portion of the 3D display 101 at a predetermined angle, to thereby change the direction of the light. Successively, the autostereoscopic 3D display apparatus 10 transmits half of the light reflected from the total reflection mirror 104 and reflects the remaining half through the half reflection mirror 105 that is disposed parallel to the total reflection mirror 104 and meets the upper edge portion of the 3D display 101 at a predetermined angle, thereby providing a user with a 3D image.

Therefore, according to the examples described above, since the 3D display 101 is disposed in a standing position, it may deflect much less than conventional displays. Specifically, when a parallax barrier is used to provide autostereoscopic 3D images, if a deflection of the autostereoscopic 3D display apparatus is reduced, the distance between the parallax barrier and a panel is maintained constant, which significantly reduces distortion of 3D images compared to when a conventional 3D display that is lying in a horizontal position is used.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An autostereoscopic 3-Dimensional (3D) display apparatus comprising:
a 3D display disposed in a standing position and configured to output a 3D image; and
a reflection structure configured to reflect the 3D image output from the 3D display and provide the 3D image in a 3D space.

2. The autostereoscopic 3D display apparatus of claim 1, wherein the reflection structure comprises:
a total reflection mirror configured to totally reflect light emitted from a screen of the 3D display, and to change a direction of the light; and
a half reflection mirror configured to half reflect the light reflected from the total reflection mirror, thereby providing the user with the 3D image.

3. The autostereoscopic 3D display apparatus of claim 1, wherein the 3D display comprises:
an image display configured in a panel structure; and
a view separation unit disposed in front of or behind the image display unit and configured to form a view blocking pattern for separating a display area of the image display unit according to the user's left and right eyes such that different images are seen by the user's left and right eyes.

4. The autostereoscopic 3D display apparatus of claim 3, wherein the image display unit and the view separation unit are disposed in standing positions to reduce a deflection of the image display unit and the view separation unit, compared to when the image display unit and the view separation unit are lying in horizontal positions, so that an interval between the image display unit and the view separation unit is maintained constant.

5. The autostereoscopic 3D display apparatus of claim 3, wherein the view separation unit is a parallax barrier.

6. The autostereoscopic 3D display apparatus of claim 2, wherein the 3D image output from the 3D display is reflected by the total reflection mirror and the half reflection mirror, to form the 3D image on a projection surface which is a virtual surface, so that the user is able to view the 3D image on the projection surface, the projection surface being in line with the 3D display.

7. The autostereoscopic 3D display apparatus of claim 2, wherein the 3D display and the total reflection mirror are installed in an opaque frame, so that the user views neither the 3D display nor the total reflection mirror externally.

8. The autostereoscopic 3D display apparatus of claim 7, wherein an inner surface of the opaque frame is coated with a nonreflective material.

9. The autostereoscopic 3D display apparatus of claim 2, wherein the total reflection mirror meets a lower edge portion of the 3D display at a predetermined angle.

10. The autostereoscopic 3D display apparatus of claim 9, wherein the predetermined angle is 45 degrees.

11. The autostereoscopic 3D display apparatus of claim 2, wherein the half reflection mirror is disposed parallel to the total reflection mirror and meets the upper edge portion of the 3D display at a predetermined angle.

12. The autostereoscopic 3D display apparatus of claim 11, wherein the predetermined angle is 45 degrees.

13. The autostereoscopic 3D display apparatus of claim 2, wherein the total reflection mirror and the half reflection mirror each have flat structures.

14. A method of displaying a 3D image using an autostereoscopic 3-Dimensional (3D) display apparatus, comprising:
outputting a 3D image through a 3D display disposed in a standing position; and
reflecting the 3D image output from the 3D display using a reflection structure to form the 3D image in a 3D space.

15. The method of claim 14, wherein the forming of the 3D image in the 3D space comprises:
totally reflecting light emitted from a screen of the 3D display, through a total reflection mirror that meets a lower edge portion of the 3D display at a predetermined angle, to change a direction of the light; and
half reflecting the light reflected by the total reflection mirror, through a half reflection mirror that is disposed parallel to the total reflection mirror and meets an upper edge portion of the 3D display at a predetermined angle, thereby providing a user with the resultant 3D image.
